(19) United States
(12) Patent Application Publication
(10) Pub. No.: US 2015/0031387 A1
(43) Pub. Date: Jan. 29, 2015

(54) COMPENSATION OF THE SIGNAL ATTENUATION BY HUMAN BODY IN INDOOR WI-FI POSITIONING

(71) Applicant: TEXAS INSTRUMENTS INCORPORATED, Dallas, TX (US)

(72) Inventor: Mohamed Farouk MANSOUR, Richardson, TX (US)

(73) Assignee: TEXAS INSTRUMENTS INCORPORATED, Dallas, TX (US)

(21) Appl. No.: 13/951,912

(22) Filed: Jul. 26, 2013

(51) Int. Cl. G01S 5/02; H04W 4/02

(52) U.S. Cl. CPC G01S 5/0215; H04W 4/02
USPC 455/456.1

(57) ABSTRACT

A mobile wireless device that includes a positioning system to determine a position of the mobile wireless device and to compensate a received signal strength indicator (RSSI) signal received from an access point (AP) when there is a line-of-sight (LOS) channel and the positioning system determines the body of the user of the mobile wireless device is attenuating the received RSSI signal due to the user's body being between the mobile wireless device and the AP.

### CROSS-REFERENCE TO RELATED APPLICATION

None.

### BACKGROUND

Mobile wireless devices have begun to migrate their positioning technology indoors. Applications may use the indoor positioning data to locate the device and user on indoor maps and to potentially guide them to areas of interest. Indoor positioning may use wireless local area network's (WLAN) Wi-Fi signals to estimate the device's location. Various position estimation techniques may be used and the strength of the received Wi-Fi signals may periodically be attenuated due to various obstructions. An attenuated Wi-Fi signal may alter the position estimation giving a less accurate position, which may lead to applications not properly functioning or a potential rescue operation not targeting the best location.

### SUMMARY

The problems noted above are solved in large part by a mobile wireless device that includes a positioning system to determine a position of the mobile wireless device and to compensate a received signal strength indicator (RSSI) signal received from an access point (AP) when there is a line-of-sight (LOS) channel and the positioning system determines the body of the user of the mobile wireless device is attenuating the received RSSI signal due to the user's body being between the mobile wireless device and the AP.

Another embodiment for compensating for attenuation of Wi-Fi signals may be a positioning system for a mobile wireless device that includes a transceiver to receive a received signal strength indicator (RSSI) signal from a Wi-Fi access point (AP) and a positioning system coupled to the transceiver to determine a position of a mobile wireless device. The positioning system includes a compensation unit to compensate the RSSI signal when the positioning system determines that a user's body of the mobile wireless device is attenuating the RSSI signal due to the user being located between the mobile wireless device and the AP from which the RSSI signal is being received, wherein the compensation is performed before the positioning system computes the position estimate for the mobile wireless device. The positioning system also includes a position estimator coupled to the compensation unit to estimate the position of the mobile wireless device with the RSSI signals.

Yet another embodiment is a method to compensate indoor positioning signals for a mobile wireless device that includes receiving a wireless signal from an access point (AP), determining whether the body of the user of the mobile wireless device is attenuating the wireless signal, and compensating the wireless signal when it is determined that the wireless signal is being attenuated due to the body of the user.

### BRIEF DESCRIPTION OF THE DRAWINGS

For a detailed description of exemplary embodiments of the invention, reference will now be made to the accompanying drawings in which:

FIG. 1 shows a WLAN and attenuation of a signal from one AP by user's body;

FIG. 2 is another example of a WLAN 100;

FIG. 3 is a block diagram of the mobile wireless device in accordance with various examples; and

FIG. 4 is an example method for implementing compensation of body attenuated W-Fi signals in accordance with various examples.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

For indoor positioning applications, the received signal strength indicator (RSSI) of a Wi-Fi signal may be used to estimate a position of a mobile wireless device. The RSSI signals received from an AP may be used to determine the distance from the device to the AP based on the level of signal strength. The Wi-Fi signals may be coming from a number of different access points (APs) of a wireless local area network (WLAN) associated with an indoor public space or a large industrial complex, for example. The mobile wireless device may measure the RSSI signals from multiple APs and then convert the signal strength data into a distance or range (possibly in meters but the unit may be irrelevant) to estimate the device's position. The mapping form RSSI to distance may affect the accuracy of the estimated position due to RSSI signal inaccuracies. In many cases, the mobile wireless device may be held by a user either up to the user's ear or in front of the user so the device's screen is visible, which may lead to RSSI signal inaccuracies due to signal attenuation.

In these situations, especially when the user is holding the device in front of her, the user's body may attenuate one or more of the AP signals affecting the RSSI measurement. RSSI signal attenuation may occur when the body of the user is between the AP and the device thereby interfering with the RSSI signal.

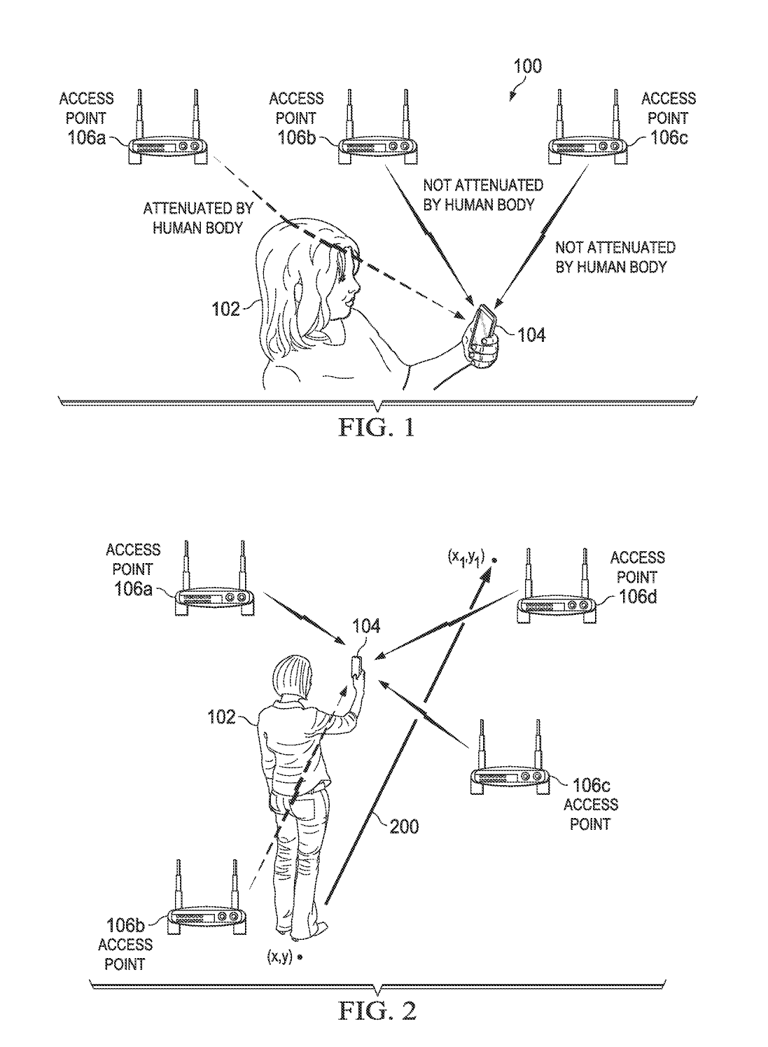

FIG. 1 shows a WLAN 100 and attenuation of a signal from one AP by user's body. The WLAN 100 may comprise a plurality of APs, such as APs 106a-c and the APs 106a-c may be placed in elevated positions for the area covered by the WLAN 100. A user 102 carrying a mobile wireless device 104 may be moving around in the WLAN 100's area. As the user 102 moves around, the user's relation to the various APs 106a-c changes. As the user 102 moves around, the mobile wireless device 104 may periodically estimate the user 102's position within the WLAN 100. As part of the position estimation process, the mobile wireless device 104 may measure the RSSI signals being received from the APs 106a-c. The RSSI signals may be the bases of the position estimation.

Occasionally, and depending on the user 102's trajectory or movement vector, the body of the user 102 may become disposed between an AP and the mobile wireless device 104. As shown in FIG. 1, the user 102's body is between the AP 106a and the mobile wireless device 104 so that the Wi-Fi signals received from the AP 106a are attenuated by the user 102's body. The Wi-Fi signals received from the APs 106b,c may not be attenuated since the user 102's body is not between those APs and the mobile wireless device 104. However, as the user 102 continues to roam around the WLAN 100, attenuation of other AP signals may periodically occur and attenuation of previous AP signals may cease to occur. When such attenuation occurs, the mobile wireless device 104's position estimation may provide an incorrect position estimate due to ranging errors unless compensation of the Wi-Fi signals from the AP(s) occurs.

Disclosed herein are a device, a system and a method for compensating attenuated Wi-Fi signals used for indoor positioning. A mobile wireless device, before estimating its position, may first compute the distance between its current position and an AP. If the distance is less than a first threshold or greater than a second threshold, then the Wi-Fi signal may not be compensated. If, however, the distance is between the two thresholds, a further determination of whether the mobile wireless device is moving away from an AP, which may imply the user of the mobile wireless device is between the AP and the mobile wireless device. If it is determined that the user's body may be between the AP and the mobile wireless device, then it is likely the W-Fi signals from that AP are being attenuated. The attenuated Wi-Fi signal may then be compensated by the mobile wireless device to enhance indoor positioning.

FIG. 2 is another example of a WLAN 100. The WLAN 100 may comprise the APs 106a-d and the user 102 with mobile wireless device 104 may be roaming around within the bounds of the WLAN 100. The FIG. 2 depicts four APs, but this disclosure would work equally well with other numbers of APs. The trajectory of the user 102 may be depicted by the arrow 200. The user 102 with the mobile wireless device 104 may be moving from location (x, y) to location (x1, y1) via the direct route shown by the arrow 200. As the user 102 moves from the first position to the second position, the relative angles and distances between the user 102, the mobile wireless device 104, and the various APs 106a-d change. Periodically, the user 102's body may come between the mobile wireless device 104 and one of the APs, such as the AP 106b in FIG. 2, when this occurs the Wi-Fi signal from the AP 106b may be attenuated by the user 102's body. The user 102's body may nominally attenuate, e.g., by 3 to 5 dBm, the Wi-Fi signal.

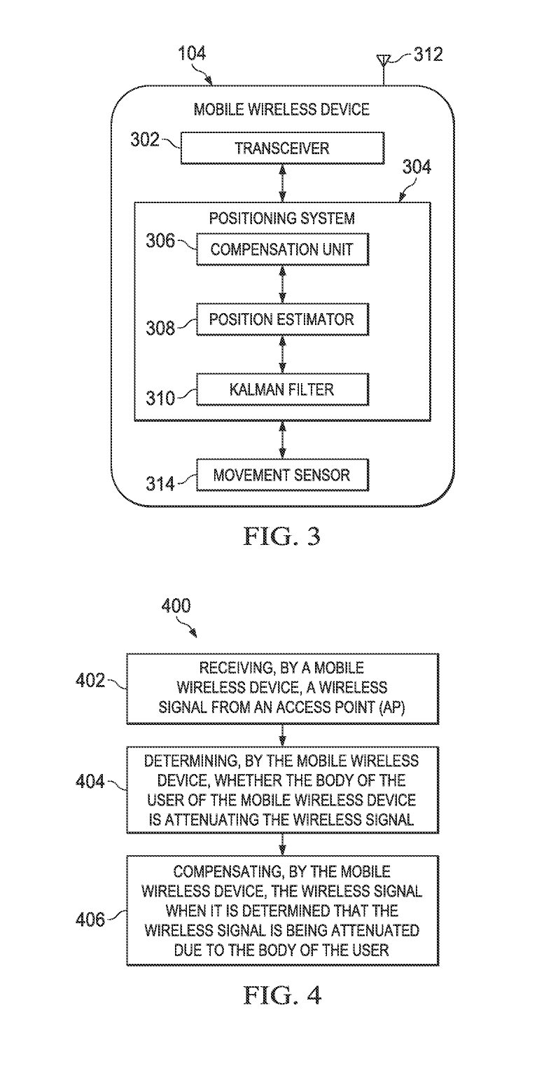

FIG. 3 is a block diagram of the mobile wireless device 104 in accordance with various examples as discussed herein. The mobile wireless device 104 may include a transceiver 302, an antenna 312, a positioning system 304, and a movement sensor 314. The positioning system 304 may include a compensation unit 306, a position estimator 308, and a Kalman filter 310. The mobile wireless device 104 may send and receive Wi-Fi signals using the transceiver 302 via the antenna 312 so to communicate with the various APs 106a-d. Periodically, the mobile wireless device 104 may estimate its position using RSSI signals received from the APs 106a-d and measured by the positioning system 304. Before estimating the device's position, however, the mobile wireless device 104 may determine if any of the received RSSI signals have been attenuated by the user 102's body and thus require compensation. By determining whether the body of the user 102 is between one of the APs 106a-d and the mobile wireless device 104, the compensation unit 306 may determine if the RSSI signal coming from that AP 106a-d required compensation.

The detection of the user 102's movement by the mobile wireless device 104 may be computed in many ways such as by the sensor 314 (e.g., a magnetometer or a gyroscope), or from the earlier history of the positioning system 304. Additionally, the trajectory or vector of the movement of the mobile wireless device 104 may be computed in part by the Kalman filter 310. Any attenuation experienced by the mobile wireless device 104 may be experienced when the direction of movement is away from the AP and the user's body interferes with the Wi-Fi signals received from the AP, i.e., when the direction of movement is close to 180° away from the AP. Stated another way, attenuation of the Wi-Fi signals received from an AP may occur when the body of the user 102 is in between an AP and the mobile wireless device 104. The user's body may interfere with the AP signals and attenuate them making the Wi-Fi signals from that AP weaker. Referring to FIG. 2, when the user 102 holds the mobile wireless device 104 in front of her and follows the trajectory arrow 200 from position (x, y) to position (x1, y1), the user 102's body may come between the AP 106b and the mobile wireless device 104. As such, the compensation unit 306 may compensate the RSSI signals received from the AP 106b. The RSSI signals received by the mobile wireless device 104 from the other three APs (10ba,c,d) may not be compensated due to the direct line of sign (LOS) between those APs and the mobile wireless device 104.

The closer the angle between the user 102's trajectory as computed in part by the Kalman filter 310 and a vector from an AP, such as AP 106b, to a current or future position of the user 102, such as position (x1, y1), the more the RSSI signal attenuation experienced by the mobile wireless device 104. Furthermore, the attenuation may be more pronounced when the LOS component in the received RSSI signal is large, meaning the user 102 is close to the AP 106b. For example, when the user 102 is directly under an AP or within a minimum threshold, the user's body may not come between the device and the AP or the signal strength is such that the attenuation may not affect the measurement. On the other hand, when the distance between the user 102 and the AP is further than a maximum threshold, the channel, or RSSI signal, may likely be a Non-Line-Of-Sight (NLOS) channel, which may not receive compensation by the compensation unit 306.

The distance between the various APs 106a-d and the mobile wireless device may be determined from the RSSI signals received from each of the APs. As used herein, the RSSI signals received from an AP may also be referred to as channels. A channel may also have a model associated with it that may be used by the positioning system 304 to determine information about the various APs 106a-d, e.g., location of the AP. Some of the channels between the mobile wireless device 104 and the APs 106a-d are LOS and others are NLOS, which may affect how the channels are treated by the compensation unit 306. Different channel models, LOS and NLOS, may be applied to the two cases. A LOS channel model may imply that there is a direct connection between the mobile wireless device 104 and an AP such that the received RSSI signals behave a free space propagation model. A NLOS model may imply that the mobile wireless device 104 and an AP are not in a direct connection because the received signals reflect off of one or more surfaces before reaching the mobile wireless device 104.

The channel models may be one method the positioning system 304 determines distances to the various APS 106a-d. The composite channel model (combing LOS and NLOS models applied to the received RSSI signals from the various APs 106a-d) may then be used for estimating the ranges to each of the APs 106a-d and henceforth the user 102's position.

The compensation of the attenuation caused by the user 102's body may be performed as a preprocessing step for the RSSI measurements before the position estimator 308 estimates the position of the mobile wireless device 104. The position estimator 308 may use the RSSI measurements, both compensated and uncompensated, to estimate the position of the device with a positioning algorithm.

The positioning system 304 may search over a set of position candidate positions to find the best position estimate that matches the RSSI readings. At each candidate position, such as the position (x1, y1), the positioning system 304 may compute an angle between the trajectory 200 of the user 102 and the various APs 106a-d. If the computed angle between the trajectory 200 and an AP, such as the AP 106b, is between about 160° to 200°, the RSSI measurement from the AP 106b may be compensated by the compensation unit 306. The compensation value may be added to the RSSI measurements received from the AP and may be limited to a small value, e.g., 3 dBm to 5 dBm, to avoid excessive change in the RSSI measurements. Furthermore, as discussed above, the compensation unit 306 may limit the RSSI measurements compensated to a range of distances that are typical for LOS channels and when the mobile wireless device 104 may not be located immediately underneath an AP, e.g., a minimum threshold of 10 meters and a maximum threshold of 20 meters from an AP.

FIG. 4 is an example method 400 for implementing compensation of body attenuated W-Fi signals in accordance with various examples as discussed herein. The method 400 begins at step 402 with receiving, by a mobile wireless device, a wireless signal from an AP. The mobile wireless device may be similar to the mobile wireless device 104 and the received wireless signals may be RSSI signals from one of a plurality of APs, such as the APs 106a-d.

Upon receiving the RSSI signals, the positioning system 304 may determine the distance between a current or future position of the mobile wireless device 104 with each of the APs 106a-d. If the distance between the mobile wireless device and an AP, such as AP 106a, is less than a minimum threshold, e.g. 10 meters, or greater than a maximum threshold, e.g. 30 meters, then the positioning system 304 may not compensate the RSSI signals from that AP. However, any of the APs, such as AP 106b, that falls within that range may be further analyzed to determine if the user 102's body is between the AP and the mobile wireless device 104.

The method 400 continues at step 404 with determining, by the mobile wireless device, whether the body of the user of the mobile wireless device is attenuating the wireless signal. For APs that may fall within the distance range between the minimum and maximum threshold away from the mobile wireless device 104, the positioning system 304 may determine if the user 102's body is between an AP and the mobile wireless device 104. In making this determination, the positioning system 304 may compute a unit vector between the current position or a future position of the mobile wireless device 104 and each of the APs that are in the distance range away from the device.

The positioning system may then compute a vector for the mobile wireless device 104's movement, such as trajectory 200, which may be provided by the Kalman filter 310. A cross correlation between the unit vectors for the APs and the trajectory 200 may then be computed by the positioning system 304. The cross correlation is a measure of similarity between the two vectors, the unit vector for each AP and the trajectory 200. Further, the cross correlation may show if the trajectory of the mobile wireless device 104 and the user 102 is similar to the unit vector. Any other techniques for estimating the angle between the moving trajectory and a unit vector between the mobile wireless device 104 and an AP may also be covered by this disclosure. The method discussed is for illustrative proposes only and is not a limiting disclosure.

The method 400 then continues at step 406 with compensating, by the mobile wireless device, the wireless signal when it is determined that the wireless signal is being attenuated due to the body of the user. The positioning system 304 may compensate the RSSI signals received from an AP when the cross correlation associated with that AP is less than a maximum threshold, e.g. −0.9. A cross correlation value below the maximum threshold may show that the mobile wireless device is moving away from the AP and the user 102's body may likely be between the AP and the mobile wireless device 104. The maximum threshold for the cross correlation calculation may affect the range of angles covered when compensating the RSSI signals as discussed above.

Referring back to FIG. 2, the user 102 with mobile wireless device 104 may be moving along trajectory 102, and, as such, the user's body may be attenuating the RSS signals received from the AP 106b. For cross correlation values below the maximum threshold, the compensation unit 306 may compensate the RSSI signals associated with that AP by a correction value that reflects the amount of attenuation, e.g., 3 to 5 dBm.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A mobile wireless device, comprising:
a positioning system to determine a position of a mobile wireless device and to compensate a received signal strength indicator (RSSI) signal received from an access point (AP) when there is a line of sight channel and the positioning system determines the body of the user of the mobile wireless device is attenuating the received RSSI signal due to the user's body being between the mobile wireless device and the AP.

2. The device of claim 1, wherein the compensation of the RSSI signal is performed before the positioning system estimates the position of the mobile wireless device.

3. The device of claim 1, wherein the RSSI signal is compensated by increasing the received signal magnitude.

4. The device of claim 1, wherein the positioning system determines a distance from the mobile wireless device to the AP.

5. The device of claim 4, wherein the positioning system does not compensate the RSSI signal if the distance shows that the mobile wireless device is underneath the AP.

6. The device of claim 1, wherein the positioning system determines an angle between a vector of movement of the mobile wireless device and the AP.

7. The device of claim 6, wherein the positioning system compensates the RSSI signal based on the angle being around 180 degree.

8. A positioning system for a mobile wireless device, comprising:
a transceiver to receive a received signal strength indicator (RSSI) signal from a Wi-Fi access point (AP); and
a positioning system coupled to the transceiver to determine a position of a mobile wireless device, comprising:
a compensation unit to compensate the RSSI signal when the positioning system determines that a user's body of the mobile wireless device is attenuating the RSSI signal due to the user being located between the mobile wireless device and the AP from which the RSSI signal is being received, wherein the compensation is performed before the positioning system computes the position estimate for the mobile wireless device; and
a position estimator coupled to the compensation unit to estimate the position of the mobile wireless device with the RSSI signals.

9. The system of claim 8, wherein the positioning system determines a trajectory of movement of the mobile wireless device with respect to the AP.

10. The system of claim 9, wherein the trajectory of the mobile wireless device is computed in part by a Kalman filter or by a movement sensor.

11. The system of claim 9, wherein the positioning system determines the distance between the mobile wireless device and the AP.

12. The system of claim 11, wherein the compensation unit compensates the RSSI signal received from the AP based on the trajectory being away from the AP and the distance between the mobile wireless device and the AP being within a range.

13. The system of claim 12, wherein the range is defined by a typical range of a line of sight channel.

14. The system of claim 8, wherein the compensation unit compensates the RSSI signal by increasing the received signal's magnitude.

15. The system of claim 14, wherein the magnitude of the RSSI signal is increased by a value that is proportional to the amount of attenuation.

16. A method to compensate indoor positioning signals for a mobile wireless device, comprising:
receiving, by a mobile wireless device, a wireless signal from an access point (AP);
determining, by the mobile wireless device, whether the body of the user of the mobile wireless device is attenuating the wireless signal; and
compensating, by the mobile wireless device, the wireless signal when it is determined that the wireless signal is being attenuated due to the body of the user.

17. The method of claim 16, further comprising:
computing, by the mobile wireless device, a trajectory of the mobile wireless device; and
determining, by the mobile wireless device, a distance between the mobile wireless device and the AP.

18. The method of claim 17, wherein compensating the wireless signal occurs when the trajectory is away from the AP and the distance is within a range.

19. The method of claim 18, wherein the range is such that there exists a direct line of sight link between the mobile wireless device and the AP.

20. The method of claim 16, further comprising estimating, by the mobile wireless device, a position of the mobile wireless device based on at least the compensated wireless signal.
